(19) United States
(12) Patent Application Publication
(10) Pub. No.: US 2011/0104536 A1
(43) Pub. Date: May 5, 2011

(54) ELECTRODE FOR ENERGY STORAGE MEANS

(76) Inventors: Tim Schaefer, Niedersachswerfen (DE); Andreas Gutsch, Luedinghausen (DE)

(21) Appl. No.: 12/747,083

(22) PCT Filed: Nov. 26, 2008
(86) PCT No.: PCT/EP08/10035

§ 371 Date: Dec. 2, 2010

(30) Foreign Application Priority Data
Dec. 10, 2007 (DE) 10 2007 059 443.9

(51) Int. Cl. H01M 4/66; H01M 10/02; H01M 10/36; H01G 4/00; H01G 9/00

(52) U.S. Cl. 429/94; 429/245; 429/152; 361/271; 361/500

(57) ABSTRACT

An energy storage unit, such as a galvanic cell, is composed of a first electrode (10), a second electrode (18) and a separation element (24), which is arranged between the first and the second electrode. Therein, the first and the second electrode (10, 18), respectively, comprise an electrode collector (12, 20) and an active electrode material (14, 22), which is applied onto the respective electrode collector on one side or on both sides. In order to improve the longterm stability, in particular for large format lithium-ion cells, the electrode collector (12, 20) of the first and/or the second electrode (10, 18) is made of a copper material, which is technical-grade oxygen-free having at least approximately 99.9% by weight copper and a specific phosphorous content.

The present invention relates to an electrode for an energy storage unit and to an energy storage unit comprising such an electrode.

Energy storage units are of increasing importance for electrical vehicles and electrical hybrid vehicles thus leading to an increasing demand for energy storage units having an increased capacity, high performance and long-time stability. Among energy storage units Lithium(-ion) cells are of particular importance in particular as secondary cells, due to their high specific energy storage density.

An example of a stacked lithium-ion cell is disclosed in DE 10 2005 042 916 A1. An example of a wound lithium-ion cell is disclosed in EP 949 699 B1. Therein, the energy storage unit provided as a lithium-ion cell, respectively, comprises a first electrode, a second electrode and a separation element between the first and the second electrode, respectively an alternatingly stacked arrangement of these components. As is disclosed in more detail, for example, in DE 10 2005 042 916 A1, electrodes typically comprise an electrode collector, onto which an active electrode material is applied on one side or on both sides. In case of a lithium-ion cell, the anode often comprises an anode collector made of copper and an active anode material that can be, for example, graphite, while the cathode is often formed based on a cathode electrode collector made of aluminium and an active cathode material based on lithiated oxides.

One object of the present invention is to provide an energy storage unit having improved long-term stability, or to provide an electrode for such an energy storage unit, respectively.

According to a first aspect, this object is solved by an electrode for an energy storage unit having the features of claim 1. Preferred embodiments and further developments of the invention are the subject-matter of dependent claims 2 to 6.

The electrode for an energy storage unit comprises an electrode collector and an active electrode material, which is applied onto the electrode collector on one side or on both sides. According to the invention, an electrode collector is formed out of technical grade oxygen-free copper material having a copper content of at least 99.9% by weight and also having an amount of phosphorous.

Part of the phosphorous in the copper material for the electrode collector binds the entire free oxygen of the copper material and therefore guarantees resistance against hydrogen. Any phosphorous that is furthermore available is dissolved interstitially in the lattice and therefore results in a high resistance against hydrogen in case of oxidizing heat treatment, as well as in increased recrystallization temperatures. In other words, the material for the electrode collector is essentially a phosphorous-deoxidized copper.

The phosphorous oxide particles, which are formed in the copper material based on the phosphorous content function as nucleation centers upon solidification and create a finely grained and homogenous crystal lattice. This finely-grained lattice leads to a more evenly distributed current load over the area of the electrode collector and therefore reduces the potential for damage to the crystal structure. In other words, the long-term stability of the electrode is significantly increased. In essence, the electrical conductivity of such a copper material is comparable to the conductivity of a commonly used copper material according to the art, which essentially is made of a technical grade oxygen-free copper material without deoxidation means.

The electrode configured as described above is therefore of particular use for large format energy storage units, having a great capacity and high performance, i.e. of the type as needed, for example, for electrical vehicles and electric hybrid vehicles.

Preferably, the copper material of the electrode collector comprises at least about 99.95% by weight of copper.

The phosphorous content of the copper material of the electrode collector preferably is in a range of approximately 0.001 to approximately 0.10% by weight, further preferably in a range of approximately 0.002 to approximately 0.007% by weight.

According to a second aspect, the above-mentioned object is solved by means of an energy storage unit having the features of claim 7. Advantageous embodiments and further developments of the invention are the subject-matter of dependent claims 8 to 14.

The energy storage unit comprises a first electrode (e.g. negative electrode, anode), a second electrode (e.g. positive electrode, cathode) and a separation element between the first and the second electrode, which prohibits a direct electrical contact between the two electrodes. Therein, the first and/or the second electrode are realized as an electrode as described above.

As has been described above, the long-term stability of the electrode can be improved by means of an electrode that is configured in accordance with the invention, wherein evidently the long-term stability of the entire energy storage unit is also significantly improved.

The energy storage unit may be, for example, a secondary cell (i.e. a galvanic cell that is rechargeable), a primary cell (i.e. a non-rechargeable galvanic cell), a capacitor or the same. The usage of the electrode according to the invention in a lithium(-ion) cell is particularly preferred.

In a further embodiment of the invention, the energy storage unit comprises a stack of a plurality of first electrodes and a plurality of second electrodes, which are stacked alternatingly one on top of the other, wherein a separation element is arranged between first and second electrode, respectively.

The present invention is of advantageous use for energy storage units, in which the first and the second electrode(s) is/are stacked, as well as for such energy storage units, in which the first and the second electrode(s) is/are wound.

The features and advantages as described above, as well as further features and advantages of the invention, can be better understood in light of the following description of preferred non-limiting examples and embodiments, and making reference to the enclosed drawings. The same show:

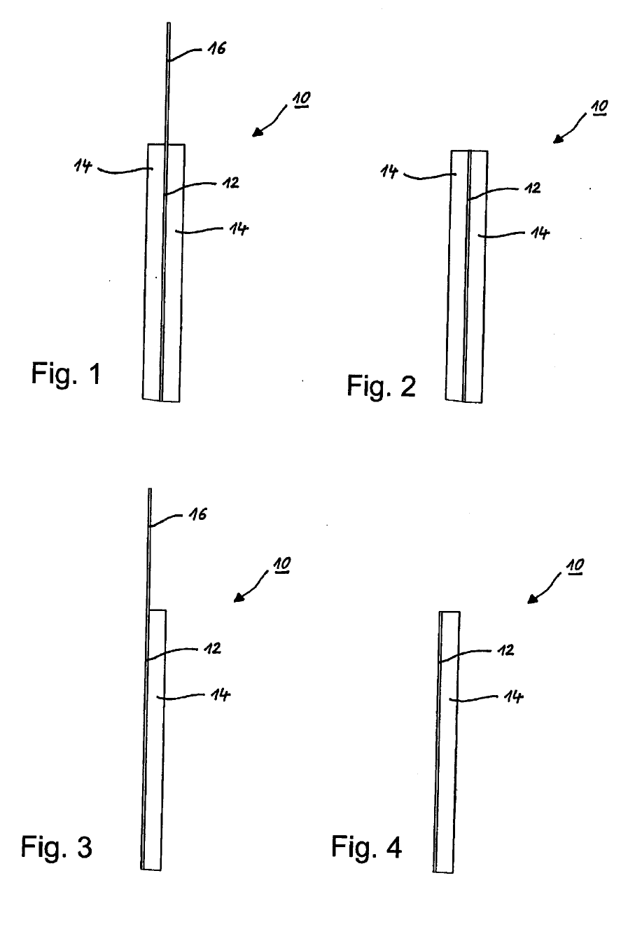

FIG. 1 schematic sectional view of an electrode according to a first embodiment of the invention;

FIG. 2: schematic sectional view of an electrode according to a second embodiment of the invention;

FIG. 3: schematic sectional view of an electrode according to a third embodiment of the invention;

FIG. 4: schematic sectional view of an electrode according to a fourth embodiment of the invention;

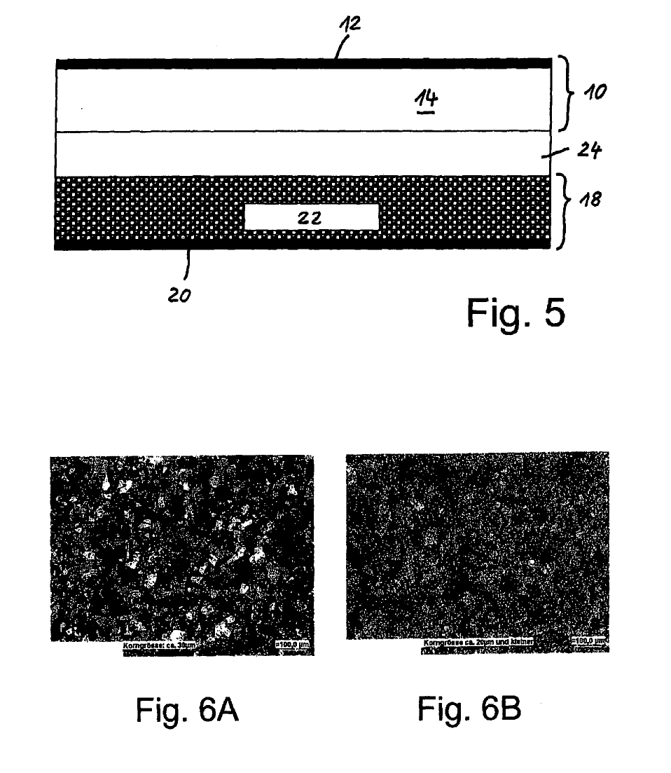

FIG. 5 schematic sectional view of an energy storage unit comprising an electrode according to the invention;

FIG. 6A depiction of a crystal lattice structure of a conventional electrode collector; and

FIG. 6B depiction of a crystal lattice structure of an electrode collector in accordance with the present invention.

In a first step, various examples for an electrode of the energy storage unit are explained in more detail, making reference to FIGS. 1 to 4.

FIG. 1 shows a first embodiment of an electrode, which is configured in accordance with the present invention and which is used for an energy storage unit (sectional view). Electrode 10 comprises an electrode collector 12, on which an active electrode material 14 is applied on both sides. In accordance with the embodiment of FIG. 1, the active electrode material 14 is not applied over the entire area of the electrode collector so that the electrode collector 12 protrudes on at least one side beyond the active electrode material 14. This part of the electrode collector 12, which protrudes beyond the active electrode material 14, can therefore be used as a current conductor 16 for supplying a charge current to the electrode 10 and/or for removing a discharge current from the electrode 10, respectively.

The embodiment visualized in FIG. 2 is distinct from the above-discussed first embodiment in the sense that the active electrode material 14 is applied onto the electrode collector 12 over the entire area so that the electrode collector 12 does not protrude beyond the active electrode material 14. In this case, it is possible, upon putting together the energy storage unit, that a distinct current conductor is joined with electrode collector 12 (e.g. by means of welding) as an extension of the same.

The third embodiment of the electrode as shown in FIG. 3 is distinct from the above-described first embodiment in that the electrode collector 12 is only coated on one side with the active electrode material 14.

The fourth embodiment of FIG. 4 represents a combination of the above-described second and third embodiment. This means that the active electrode material 14 is only applied on one side of the electrode collector 12 and that electrode collector 12 is essentially completely coated with the active electrode material 14 on said one side.

In all embodiments, electrode collector 12 is provided, for example, as a foil, a ribbon, a plate, or a sheet or the like or is, for example, electrolytically deposited onto rolls from a corresponding solution. The thickness of the electrode collector 12, for example, is in the range of approximately 4 μm to approximately 80 μm, preferably in the range of approximately 5 μm to approximately 50 μm, further preferred in a range of 5 μm to approximately 30 μm.

FIG. 5 showns an example of an energy storage unit making use of the above-described electrode 10.

The energy storage unit, for example a rechargeable secondary cell, a primary cell or a capacitor or the like, comprises a first electrode 10 (e.g. negative electrode or anode, respectively), a second electrode 18 (e.g. positive electrode or cathode, respectively) and a separation element 24 arranged between the two electrodes 10, 18. An electrode as shown, for example, in FIGS. 1 to 4 can be used as the first electrode 10. The second electrode 18, is, in principle, arranged in an analogous manner to the first electrode 10, i.e. said second electrode 18 also comprises an electrode collector 20 and an active electrode material 22 which is applied onto the electrode collector 20 on one side or on both sides.

The separation element 24 between the two electrodes 10, 18 prohibits a direct, electrically conducting contact between the two electrodes 10, 18. The separation element 24 may be flush with the electrodes 10, 18 (in particular the active areas 14, 22 thereof), as shown in FIG. 5. However, it may also be advantageous that the separation element 24 extends beyond the active electrode material 14, 22 of the immediately adjacent electrodes 10, 18 on at least one side.

The energy storage unit may comprise, for example, exactly one first electrode 10, one separation element 24 and one second electrode 18, as shown in FIG. 5. However, in many applications it is advantageous if the energy storage unity comprises a stack of a plurality of first electrodes 10 and a plurality of second electrodes 18, which are stacked alternatingly one on top of the other, and in which case one separation element 24, respectively, is arranged in between.

Furthermore, the energy storage unit may have the design as shown in FIG. 5 or the stack configuration, respectively, in an arrangement of a wound pack or in the shape of a stacked pack.

In accordance with the invention, a particular material is provided for the first and/or the second electrode 10, 18 of the energy storage unit. Therein, the selection of materials, as explained below, is of particular advantage for an anode 10 of a lithium ion cell, without, however, the intention to limit the present invention to this specific application.

The electrode collector 12 of electrode 10 (see FIGS. 1 through 4) for an energy storage unit (see FIG. 5) is formed out of a technical grade oxygen free copper material having at least 99.9% by weight of copper and an amount of phosphorous.

The copper content (Cu) of the copper material for the electrode collector 12 is at least 99.9% by weight, preferably at least 99.95% by weight.

The phosphorous content (P) of the copper material for the electrode collector 12 preferably is in the range of approximately 0.001 to approximately 0.010% by weight, preferably in the range of approximately 0.002 to approximately 0.007% by weight.

Further components such as, in particular Bi or Pb, which are present in commonly used copper materials are not included in the copper material according to the invention.

The advantages of the copper material as used in accordance with the present invention, in particular its improved longterm stability, can be explained as follows.

Part of the phosphorous present in the copper material binds the entire free oxygen according to the equation

5Cu₂O+2P→10Cu+P₂O₅

and therefore guarantees the resistance of the copper material against hydrogen. The content of the oxygen, which is bound via saturation according to this mechanism, is, for example, approximately 0.003% by weight for the copper material in the solidified state. Any phosphorous that is available beyond said content is interstitually dissolved in the crystal lattice and results in an increased resistance against hydrogen under oxidizing heat conditions and also results in increased recrystallization temperatures. In other words, the copper material of the invention is essentially phosphorous-deoxidized copper.

Upon solidification of the copper material, the phosphorous oxide particles as formed function as nucleation centers and form a finely-grained homogenous crystal lattice. Such a finely-grained lattice in turn results in a more evenly distributed current load over the area of the electrode collector 12 and therefore prevents destruction of the crystal structure.

To highlight this, FIGS. 6A and 6B show a comparison of the crystal lattice structure between a commonly used copper material (FIG. 6A) and the copper material according to the present invention (FIG. 6B).

In case of FIG. 6A, a copper material of a high purity (copper content 99.99% by weight) was used, which is free of oxygen and free of deoxidation means. As shown in FIG. 6a, this copper material results in a crystal lattice structure having a grain size in the order of magnitude of about 30 μm.

For a crystal lattice having a coarse grain structure, the potential danger is that a current is unevenly charged over the area of the electrode collector resulting in destruction of the crystal structure. Particles which may break off the crystal structure can be the cause for heat development and short circuits in an energy storage unit.

By contrast, FIG. 6B shows a crystal lattice structure for a copper material which is free of oxygen but has a phosphorous content as described above. This material results in a crystal lattice structure having a grain size in the order of magnitude of 20 μm and less, therefore a significantly more finely grained and more homogeneous structure.

As a specific example for the material of the electrode collector 12 of an electrode 10 for an energy storage unit, the copper material “PNA 210” of the Prymetall GmbH & Co. KG, Germany, can be used. This deoxidized copper material, which is free of oxygen, has a copper content of at least 99.95% by weight and a phosphorous content in the range of 0.002 to 0.007% by weight. Bismuth and lead are not present. The specific electrical conductivity of this copper material is approximately 57 MS/m (after annealing), its heat conductivity is approximately 385 W/m·K.

In respect to the materials used for the active electrode material 14 of the anode 10, for electrode collector 20 and for the active electrode material 22 of cathode 18 as well as in respect to the material for the separation element 24, no particular restrictions exist in the context of the present invention. Typical materials for these components, which may be used for lithium-ion cells are described, for example, exhaustively in previously mentioned DE 10 2005 042 916 A1, which is incorporated by reference herewith. Furthermore, the method of manufacturing the electrodes 10, 18 and the energy storage unit in accordance with the present invention is not restricted to specific processes.

The electrode as described above, in accordance with the invention, is particularly suited for large format energy storage units (in particular secondary lithium-ion cells) having a great capacity and a high performance capability of more than 3 or 5 Ah up to 300 Ah and more, which furthermore have an excellent longterm stability of, for example, 3,000 charge/discharge cycles and more, and which require stability in regard to energy supply. Energy storage units comprising such an electrode can be used in an advantageous manner, for example, in electric vehicles and in electric hybrid vehicles.

1. An electrode (10) for an energy storage unit, comprising
an electrode collector (12), and
an active electrode material (14), which is applied onto the electrode collector (12) on one side or on both sides;
characterized in that the electrode collector (12) is made of a copper material, which is technical-grade free of oxygen having at least 99.9% by weight copper and an amount of phosphorous.

2. The electrode according to claim 1,
characterized in that the copper material of the electrode collector (12) comprises at least approximately 99.95% by weight copper.

3. The electrode according to claim 2,
characterized in that the copper material of the electrode collector (12) comprises at least approximately 0.001% by weight of phosphorous.

4. The electrode according to claim 2,
characterized in that the copper material of the electrode collector (12) comprises at least approximately 0.002% by weight of phosphorous.

5. The electrode according to claim 2 4,
characterized in that the copper material of the electrode collector (12) comprises at most approximately 0.010% by weight of phosphorous.

6. The electrode according to claim 2 4,
characterized in that the copper material of the electrode collector (12) comprises at most approximately 0.007% by weight of phosphorous.

7. An energy storage unit comprising
a first electrode (10);
a second electrode (18); and
a separation element (24) in between the first and the second electrode,
characterized in that the first and/or the second electrode (10, 18) is/are an electrode according to claim 1.

8. The energy storage unit according to claim 7, characterized in that the energy storage unit is a secondary cell.

9. The energy storage unit according to claim 7, characterized in that the energy storage unit is a primary cell.

10. The energy storage unit according to claim 7, characterized in that the energy storage unit is a capacitor.

11. The energy storage unit according to claim 8, characterized in that the energy storage unit is a lithium-ion cell.

12. The energy storage unit according to claim 7, characterized in that the energy storage unit comprises a stack of a plurality of first electrodes (10) and a plurality of second electrodes (18), which are alternatingly stacked one on top of the other, wherein one separation element (24), respectively, is arranged in between the same.

13. The energy storage unit according to claim 7, characterized in that the first and second electrode(s) (10, 18) is/are stacked.

14. The energy storage unit according to claim 7, characterized in that the first and second electrode(s) (10, 18) is/are wound.

15. The energy storage unit according to claim 9, characterized in that the energy storage unit is a lithium-ion cell.

16. The energy storage unit according to claim 10, characterized in that the energy storage unit is a lithium-ion cell.
